(19) United States
(12) Patent Application Publication
(10) Pub. No.: US 2020/0019996 A1
(43) Pub. Date: Jan. 16, 2020

(54) MEDIA ACQUISITION WITH PROBABILISTIC MODELING

(71) Applicant: Cognant LLC, Mountain View, CA (US)

(72) Inventors: Heng Wang, San Jose, CA (US); Jerome Turnbull, Mountain View, CA (US); Arun Kejariwal, Fremont, CA (US); Wei Yang, San Jose, CA (US); Ryan DeWitt, Palo Alto, CA (US)

(21) Appl. No.: 16/459,106

(22) Filed: Jul. 1, 2019

Related U.S. Application Data
(60) Provisional application No. 62/696,919, filed on Jul. 12, 2018.

(51) Int. Cl. G06Q 30/02; G06Q 10/04; G06F 17/18

(52) U.S. Cl. CPC G06Q 30/0275; G06F 17/18; G06Q 10/04

(57) ABSTRACT

Data associated with one or more engagement events is generated for multiple users. The data associated with the one or more engagement events is aggregated for the users. Performance of one or more advertising campaigns is predicted based on the aggregated data.

### CROSS REFERENCE TO RELATED APPLICATIONS

This application claims the benefit of U.S. Provisional Patent Application No. 62/696,919, filed on Jul. 12, 2018, which is hereby incorporated by reference in its entirety.

### BACKGROUND

Digital advertising enables businesses to reach consumers through a wide variety of channels such as, but not limited to, advertising networks, ad exchanges, brokers, and direct publishers. These channels may offer means to target users at a granular level. An advertiser will typically create multiple campaigns, each targeting a semi-unique audience of users defined through a combination of targeting options. For example, a single campaign may be able target male users in Canada on iOS devices who have engaged with topics related to sports betting.

### BRIEF DESCRIPTION OF DRAWINGS

FIG. 1 illustrates an exemplary system for developing and using probabilistic models to generate bids for advertisements of advertisement campaigns.

FIG. 2 is a flowchart of an example method for generating a bid for an advertisement using a generated model.

FIG. 3 is a flowchart of an example method for determining a second bid value based on advertising network data and user data.

FIG. 4 is a flowchart of an example method for predicting the performance of advertising campaigns.

FIG. 5A is an illustration of an example of generating a bid value based on metrics describing a distribution of a non-deterministic variable in accordance with embodiments of the disclosure.

FIG. 5B is an illustration of an example of updating a bid value based on second metrics describing a second distribution of a non-deterministic variable in accordance with embodiments of the disclosure.

FIG. 5C is an illustration of an example of updating a bid value based on third metrics describing a third distribution of a non-deterministic variable in accordance with embodiments of the disclosure.

FIG. 5D is an illustration of an example of updating a bid value based on fourth metrics describing a fourth distribution of a non-deterministic variable in accordance with embodiments of the disclosure.

FIG. 6 is a block diagram of an example computing device that may perform one or more of the operations described herein, in accordance with the present embodiments.

### DETAILED DESCRIPTION

In general, the compensation paid by the content provider to the content publisher or to the network publishing the content can be based on a bid price for publishing the content, such as a digital advertisement (also referred to as “advertisement” hereafter). Advertisers must optimally price their advertising campaigns to maximize profit (e.g., the difference in amount paid versus revenue generated). Most channels offer the ability to bid on a specific event, such as an impression, click, install (in the case of mobile app install campaigns), or purchase. To submit an optimally priced bid, the advertiser must then calculate the value of these events using only the aggregated data provided by the channel.

While the advertiser ultimately wishes to bid the true value of an event (typically the estimated average revenue generated from the event), they must also consider an explore/exploit tradeoff, which corresponds to testing potentially profitable campaigns versus reaping the profits of proven, successful campaigns.

There is a relationship between the bid amount and the number of times an advertisement will be displayed, as a higher bid amount will lead to the advertiser winning a higher proportion of the impression-level auctions they enter. If the bid for an advertising campaign is too low, the advertiser may no longer receive any impressions for the advertising campaign. This means that the advertiser will no longer be able to gather data on the performance of the advertising campaign.

A system that predicts the value of an advertising campaign may, in cases with low amounts of data (also referred to as “underrepresented data” hereafter), under-predict the bid value, which may cause an early halt to exploration (e.g., the testing of potentially profitable campaigns). This can cause the advertiser to miss out on the ability to exploit the potential long-term profit from that campaign.

Turning now to embodiments of a system and method of media acquisition utilizing a probabilistic model for predicting the performance of one or more advertising campaigns. A probabilistic model (also referred to as “model” hereafter) may predict the performance of the one or more advertising campaigns, including new campaigns, without having a statistically significant amount of data associated with the advertising campaigns using processing logic of a computer processing device. The model may infer a probability distribution for the valuation of engagement events of the advertising campaigns. In some embodiments, a Bayesian inference may be used. The inference may generate data associated with one or more engagement events for a set of users. The data may be associated with an inferred probability of the one or more engagement events.

Engagement events may include paid events and/or valued events associated with advertising campaigns. Paid events may correspond to an event paid for by the advertiser. For example, the paid event may correspond to an impression, click, install, etc. associated with an advertisement. A valued event may correspond to a revenue generating event, such as a user purchase. The data generated by the inference is aggregated and used to predict the performance of one or more advertising campaigns. For example, the aggregated data may be used to determine a probability of distribution for the valuation of the engagement event of the advertising campaign.

In embodiments, a model may be used to model a distribution of the relationship between a paid event and a valued event. Using the model, the processing logic determines a distribution of a non-deterministic variable for a particular advertising campaign. In embodiments, the non-deterministic variable may correspond to a random variable. In other embodiments, the non-deterministic variable may correspond to a pseudo-random variable. For example, a distribution of a conversion rate of the paid event versus the valued event for an advertisement of an advertising campaign may be determined. In embodiments, the distribution of the non-deterministic variable may be determined by training the model through Markov Chain Monte Carlo (MCMC) sampling via Automatic Differentiation Variational Interference (ADVI) or any other suitable method of training the model.

Using the distribution of the non-deterministic variable, the processing logic generates one or more metrics that describe the distribution of the non-deterministic variable. Metrics that may be used to describe the distribution of the non-deterministic variable may include mean, median, standard deviation, variance, mode, skew, etc. For example, the one or more metrics generated by the processing logic may correspond to the mean and standard deviation of the distribution of the conversion rate.

The processing logic generates a bid value based on the one or more metrics describing the distribution of the non-deterministic variable. To prevent under-predicting the bid value, which may result in the early termination of an exploration campaign, the processing logic may select a bid value that is greater than an estimate of the bid value. For example, to prevent under-predicting the bid value, the processing logic may generate a bid value that is one or more standard deviations greater than the mean of the distribution.

Subsequently, the processing logic may receive advertising network data and user data associated with the advertisement of the advertising campaign. For example, the processing logic may receive advertising network data that corresponds to clicks or interactions with the advertisement and user data that corresponds to purchases resulting from the clicks/interactions with the advertisement. The advertising network data and the user data are entered into the model and a second distribution of the non-deterministic variable is generated. One or more second metrics are generated based on the second distribution of the non-deterministic variable. For example, a second mean value and second standard deviation may be generated to describe the distribution of the non-deterministic variable. The one or more second metrics are then used to automatically update the bid value.

As previously described, the updated bid value may be greater than an estimated bid value to prevent under-predicting the bid value. For example, the updated bid value may be one or more of the second standard deviations greater than the second mean value of the distribution of the non-deterministic variable. Aspects of the above process may be performed iteratively to automatically update the bid value as the processing logic acquires more advertising network data and user data associated with the advertisement. As more data is acquired, the standard deviation describing the distribution of the non-deterministic variable may decrease in size which, in turn, decreases the amount the updated bid value exceeds the estimated bid value. Eventually, the standard deviation may decrease to a negligible amount and the updated bid value may be equal or substantially similar to the estimated bid value.

Accordingly, embodiments of the disclosure provide for an improved system and method of media acquisition by predicting the performance of one or more advertising campaigns that do not have statistically significant amounts of data and utilizing a probabilistic model for generating and updating bid values for an advertising campaign. Utilizing the probabilistic model allows bid adjustments to be made based on the level of certainty surrounding a predicted value of a given bid. By predicting the performance of advertising campaigns and modeling a distribution of a non-deterministic variable rather than a point estimate, bid values may be selected to prevent under-predicting the bid value. By preventing the under-prediction of the bid values, the premature termination of potentially profitable exploratory advertising campaigns may be reduced or minimized.

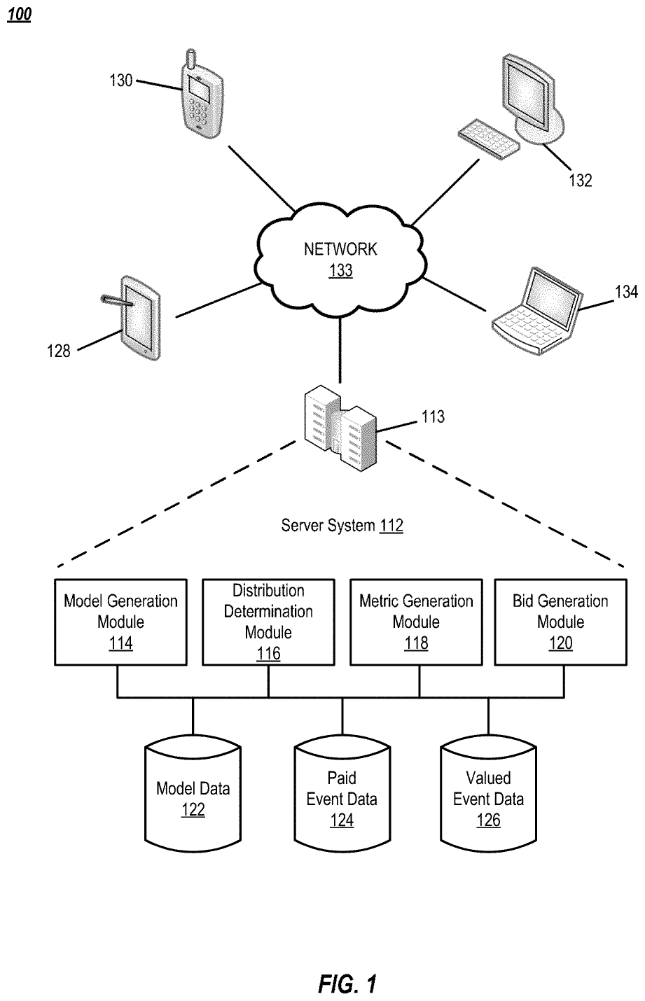

FIG. 1 illustrates an exemplary system 100 for developing and using models to generate bids for advertisements of advertisement campaigns. The server system 112 includes software components executed by one or more computer processing devices (not shown) and databases that can be deployed at one or more data centers 113 in one or more geographic locations. In some embodiments, the server system 112 is, includes, or utilizes a content delivery network (CDN). The server system 112 software components may include a model generation module 114, a distribution determination module 116, a metric generation module 118, and a bid generation module 120. The software components can include subcomponents that can execute on the same or on different individual data processing apparatuses. The server system 112 databases can include a model data 122 database, a paid event data 124 database, and a valued event data 126 database. The databases may reside in one or more physical storage systems.

In some embodiments, the system 100 can include a web-based application that can be provided as an end-user application to allow multiple users to interact with a server system 112. The application can be accessed through a network 133 (e.g., the Internet, a LAN, a WAN, and the like) by users via client devices, e.g., a tablet computer 128, a smart phone 130, a personal computer 132, a laptop computer 134, or any other types of client devices. In some embodiments, the model data 122 database, the paid event data 124 database, the valued event data 126 database, or any portions thereof can be stored on one or more client devices. Additionally or alternatively, software components for the system 100 (e.g., the model generation module 114, the distribution determination module 116, the metric generation module 118, and the bid generation module 120) or any portions thereof can reside on or be used to perform operations on one or more client devices.

In some variations, as shown in FIG. 1, the model generation module 114, the distribution determination module 116, the metric generation module 118, and the bid generation module 120 communicate with the model data 122 database, the paid event data 124 database, the valued event data 126 database. In general, the model data 122 database, the paid event data 124 database, and/or the valued event data 126 database may include or store data associated with and used by a probabilistic model to generate bids for an advertisement of an advertising campaign.

The model data 122 database may store information associated with probabilistic models generated by the model generation module 114. For example, the model data 122 database may store equations, variables, factors, etc. that are associated with the probabilistic models. The model data 122 database may also store distributions of non-deterministic variables determined by the distribution determination module 116 and corresponding metrics describing the distributions of the non-deterministic variables generated by the metric generation module 118. The model data 122 database may also store bid values generated by the bid generation module 120.

The paid event data 124 database may store information associated with paid events associated with the probabilistic models. In embodiments, the paid event data 124 database may store advertising network data associated with advertisements. For example, the paid event data 124 database may store advertising network data that correspond to clicks, installs, etc., associated with corresponding advertisements.

The valued event data 126 database may store information associated with valued events associated with the models. In embodiments, the valued event data 126 database may store user data associated with advertisements. For example, the valued event data 126 database may store user data that corresponds to user purchases resulting from a paid event (e.g., click, install, etc.).

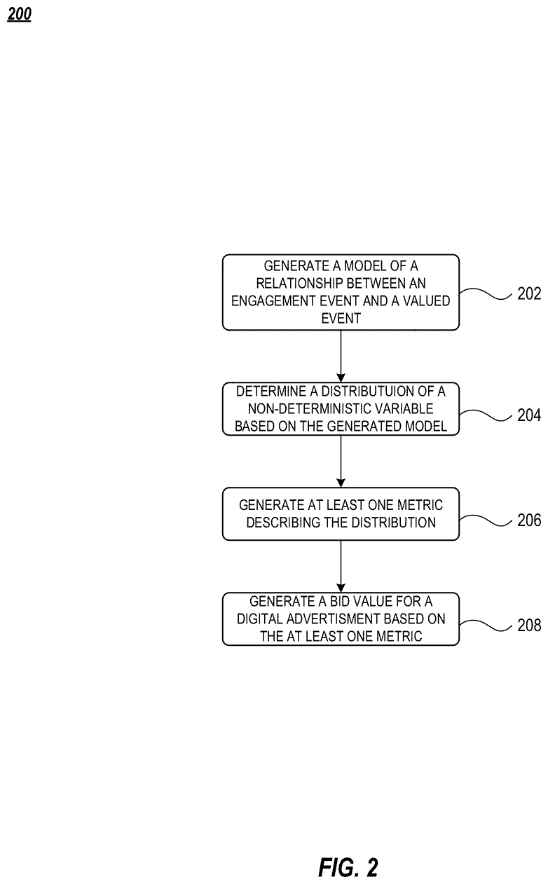

FIG. 2 is a flowchart of an example method 200 for generating a bid for an advertisement using a generated model. Method 200 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. For example, the method 200 can be implemented using processing logic of one or more computer processing devices of server system 112 illustrated in FIG. 1.

Method 200 begins at block 202, where the processing logic generates a model of a relationship between a paid event and a valued event for a digital advertising campaign. As previously described, a paid event may be an event paid for by an advertiser of an advertising campaign. For example, a paid event may be a click, interaction, install, etc., associated with an advertisement of an advertising campaign. The valued event may correspond to a value generating event resulting from the advertisement. For example, the valued event may correspond to a user purchase resulting from an interaction with the advertisement. In embodiments, the model may be a probabilistic regression model. In embodiments, the model may be generated for an advertisement campaign having underrepresented data. Data associated with the advertising campaign, such as model features, may be loaded into a matrix with columns representing the model features. Examples of model features may be targeting options of an advertising campaign, individual advertising campaign identifications, day of the week, geographic location, operating system, etc. The data is fit to the model using a selected library and observed data, such as counts of the paid event and the valued event, are provided to the model. An example of a model definition is shown below:

$${μ}_{a} ∼ Normal ( 0 , 1 )$$

$${σ}_{α} ∼ HalfCauchy ( 1 )$$

$${μ}_{β} ∼ Normal ( 0 , 1 )$$

$${σ}_{β} ∼ HalfCauchy ( 1 )$$

$${α}_{campaign} ∼ Normal ( {μ}_{a} , {σ}_{α} )$$

$${β}_{campaign} ∼ Normal ( {μ}_{β} , {σ}_{β} )$$

$$logit ( p ) = {α}_{campaign [ i ]} + {\sum }_{k = 1}^{K} {β}_{campaign [ i ] k} {X}_{ik}$$

$${y}_{i} ∼ Bernoulli ( p , k ) or Binomial ( n , p , k )$$

where:
n corresponds to the paid event.
k corresponds to the valued event.
p corresponds to the non-deterministic variable.
α_{campaign} is a vector of Normal distributions indexed by advertising campaign (e.g., one distribution per campaign) describing the intercept of the linear model for each campaign.
β_{campaign} is a matrix of Normal distributions that are the coefficients for each feature for each advertising campaign.
μ₀ is a distribution used as the prior for the mean of each distribution in α_{campaign}. The priors for μ_{α} are 0 and 1 for the mean and standard deviation, respectively. This is roughly equal to the average of all advertising campaigns.
σ₀ is a distribution used as the prior for the standard deviation of each distribution in α_{campaign}.
μ_{β} is a distribution used as the prior for the mean of each distribution β_{campaign}. The priors for μ_{β} are 0 and 1 for the mean and standard deviation, respectively.
σ_{β} is a distribution used as the prior for the standard deviation of each distribution β_{campaign}.
X is the one-hot encoded features of the training set. Examples of features may include targeting options of an advertising campaign, individual advertising campaign identifications, day of the week, geographic location, operating system, etc. Given a training set X with K features, where k=1 . . . K and i is the index of campaigns:
   β_{campaign[i][1]}X_{[i][1]} +β_{campaign[i][2]}X_{[i][2]}+ . . . +β_{campaign[i][k]}X_{[i][k]} completes a linear model.
yᵢ is a vector of posterior Bernoulli (or Binomial) distributions given the inferred rate of success p and the data provided in n and k, indexed over campaigns i.

At block 204, the processing logic determines a distribution of a non-deterministic variable for the digital advertising campaign using the generated model. For example, a distribution of a conversion rate of the paid event versus the valued event for an advertisement of an advertising campaign may be determined. As previously described, in embodiments, the distribution of the non-deterministic variable may be determined by training the model through Markov Chain Monte Carlo (MCMC) sampling via Automatic Differentiation Variational Interference (ADVI) or any other suitable method of training the model.

At block 206, the processing logic generates at least one metric describing the distribution of the non-deterministic variable. Examples of metrics that may be generated to describe the distribution of the non-deterministic variable include, but are not limited to, a mean, median, standard deviation, variance, mode or skew. In some embodiments, the at least one metric describing the distribution of the non-deterministic variable may correspond to a mean value and/or standard deviation of the distribution.

At block 208, the processing logic generates a bid value for a digital advertisement of the advertising campaign based on the at least one metric. In embodiments, an estimated bid value may be determined by multiplying a monetary value assigned an event by the probability that the event is to occur. As previously described, to prevent under-predicting the bid value for the digital advertisement, the generated metric(s) describing the distribution of the non-deterministic variable are used to generate a bid value that is greater than the estimated bid value for the digital advertisement. For example, the generated bid value may be determined using a value that is one or more standard deviations greater than a mean value of the distribution of the non-deterministic variable. In some embodiments, the generated bid value may be determined using a percentile of the determined distribution. For example, the generated bid value may correspond to the 90^{th} percentile of the distribution.

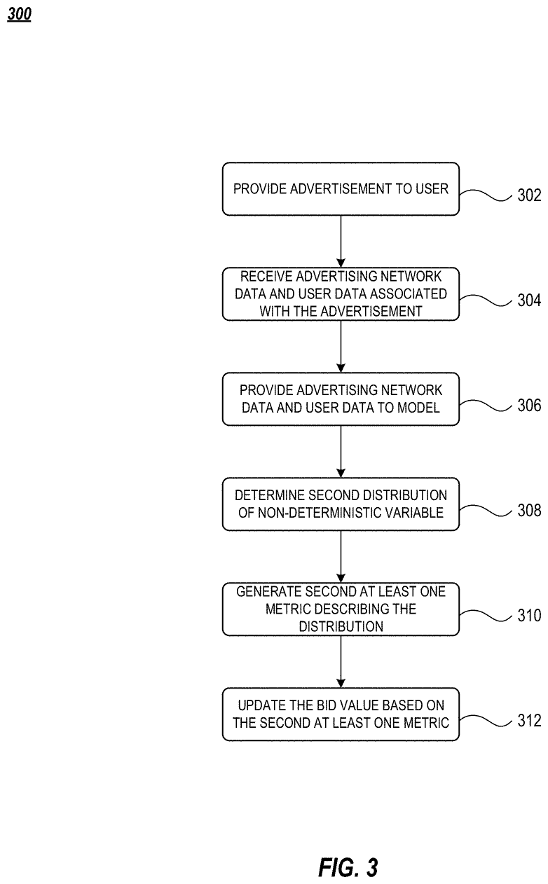

FIG. 3 is a flowchart of an example method 300 for determining a second bid value based on advertising network data and user data. Method 300 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. For example, the method 300 can be implemented using processing logic of one or more computer processing devices of server system 112 illustrated in FIG. 1.

Method 300 begins at block 302, where a digital advertisement of a digital advertisement campaign is provided to a user. In embodiments, the digital advertisement may be provided to the user by an advertising network based on a received bid. For example, the advertising network may receive a bid generated using a generated model, as previously described at FIG. 2, and provide the advertisement to the user based on the bid.

At block 304, the processing logic receives advertising network data and user data associated with the digital advertisement provided to the user. In embodiments, the processing logic may receive the advertising network data from a computing device of the advertising network and the user data may be received from a client device of the user. In some embodiments, the processing logic may receive the advertising network data and the user data from the computing device of the advertising network. In other embodiments, the processing logic may receive the advertising network data and the user data from the client device of the user.

The advertising network data may include information associated with the paid event of the model generated at block 202 of FIG. 2. For example, the advertising network data may include whether the user provided with the advertisement clicked, interacted, installed an application, etc., in response to being provided with the advertisement. The user data may include information associated with the valued event of the model. For example, the user data may include whether the user made a purchase resulting from the paid event.

At block 306, the processing logic provides the advertising network data and user data to the generated model and trains the model using the advertising network data and user data, as previously described.

At block 308, the processing logic determines a second distribution of the non-deterministic variable based on the trained model. For example, the processing logic may determine a second distribution of the conversion rate of the model.

At block 310, the processing logic generates a second at least one metric that describes the second distribution of the non-deterministic variable. For example, the processing logic may generate a second mean, median, standard deviation, etc., that describes the second distribution of the non-deterministic variable.

At block 312, the processing logic updates the bid value (e.g., the bid value at block 208 of FIG. 2) for the digital advertisement based on the second at least one metric. For example, the processing logic may update the bid value to a value that corresponds to one or more second standard deviations above the second mean of the distribution of the non-deterministic variable.

As previously discussed, all or a portion of method 300 may be performed iteratively to automatically update the bid value for a digital advertisement of a digital advertising campaign as additional data (e.g., advertising network data and/or user data) associated with the digital advertisement is received.

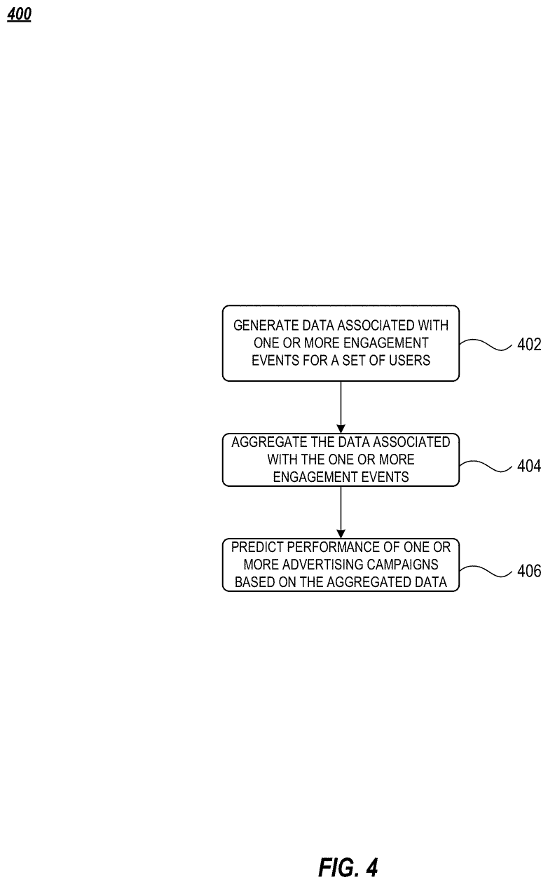

FIG. 4 is a flowchart of an example method 400 for predicting the performance of advertising campaigns. Method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof For example, the method 400 can be implemented using processing logic of one or more computer processing devices of server system 112 illustrated in FIG. 1.

Method 400 begins at block 402, where the processing logic generates data associated with one or more engagement events for a set of users. The data associated with the engagement events may be generated based on various model features, such as targeting options for advertising campaigns and campaign features (day of week, operating system, etc.), as previously described.

At block 404, the processing logic aggregates the data associated with the one or more engagement events. In embodiments, the data may be aggregated into a matrix having columns representing the various model features. The data is then fit to the model using a selected library and observed data, such as counts of the paid event and the valued event are provided to the model.

At block 406, the processing logic predicts the performance of one or more advertising campaigns based on the aggregated data. In embodiments, the processing logic may use a statistical inference to calculate a probability of distribution for a valuation of the one or more engagement events of the one or more advertising campaigns. In some embodiments, the statistical inference may be a Bayesian inference. In an embodiment, the processing logic may generate and update bid values based on the predicted performance, as previously described.

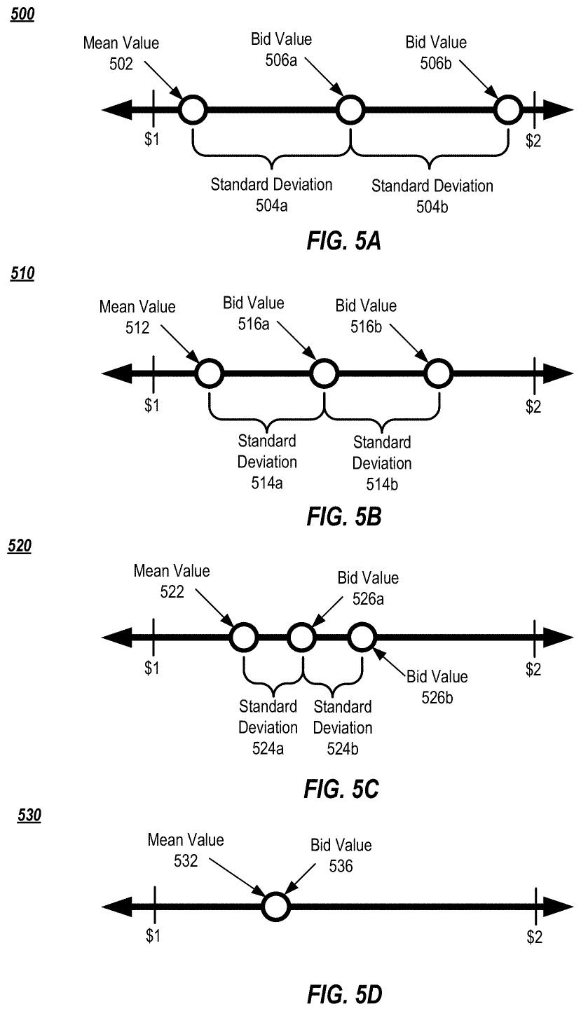

FIGS. 5A-D are illustrations of examples of generating and automatically updating bid values using methods 200 and/or 300 iteratively over time. It should be noted that FIGS. 5A-D are shown for explanation and understanding only and should not be taken to limit the disclosure to specific embodiments or implementations. For illustrative purposes, the metrics of mean and standard deviation are shown in FIGS. 5A-D. However, embodiments of the disclosure may utilize other metrics to describe the distribution of the non-deterministic variable and generate bid values, as previously described.

FIG. 5A is an illustration 500 of an example of generating a bid value based on metrics describing a distribution of a non-deterministic variable in accordance with embodiments of the disclosure. Illustration 500 includes a horizontal axis that may be representative of a bid value for a digital advertisement for a digital advertising campaign. For example, the horizontal axis may be representative of bid values ranging from $1-$2. Illustration 500 further includes a mean value 502 that corresponds to an estimated bid value for a digital advertisement that is determined using the mean of the distribution of the non-deterministic variable. Standard deviations 504a, b correspond to the value of the standard deviation of the distribution of the non-deterministic variable.

In embodiments, to prevent under-predicting a bid value for a digital advertisement having underrepresented data, the generated bid value for the digital advertisement may be one or more standard deviations 504a, b greater than the mean value 502. Accordingly, in embodiments, the generated bid value may be bid value 506a that is one standard deviation (e.g., standard deviation 504a) greater than the mean value 502. In other embodiments, the generated bid value may be bid value 506b that is two standard deviations (e.g., standard deviation 504a and standard deviation 504b) greater than the mean value 502. In embodiments, the generated bid value may be any value that is greater than the mean value 502.

FIG. 5B is an illustration 510 of an example of updating a bid value based on second metrics describing a second distribution of a non-deterministic variable in accordance with embodiments of the disclosure. Illustration 510 may correspond to a first iteration of updating a bid value for a digital advertisement. For example, illustration 510 may be representative of metrics generated for a distribution of a non-deterministic variable that is determined after receiving user data and advertising network data associated with the digital advertisement. The mean value 512 and standard deviations 514a, b may correspond to second metrics generated to describe a second distribution of the non-deterministic variable, as previously described at FIG. 3. As data associated with the digital advertisement is acquired, the size of the standard deviation of the distribution of the non-deterministic variable decreases. For example, the size of standard deviation 514a is less than the size of standard deviation 504a.

After generating the mean value 512 and standard deviations 514a, b, in embodiments, the bid value generated at FIG. 5A may be updated to bid value 516a that is one standard deviation (e.g., standard deviation 514a) greater than the mean value 512. In other embodiments, the bid value generated at FIG. 5A may be updated to bid value 516b that is two standard deviations (e.g., standard deviation 514a and standard deviation 514b) greater than mean value 512.

FIG. 5C is an illustration 520 of an example of updating a bid value based on third metrics describing a third distribution of a non-deterministic variable in accordance with embodiments of the disclosure. Illustration 520 may correspond to a second iteration of updating a bid value for a digital advertisement. For example, illustration 520 may be representative of metrics generated for a distribution of a non-deterministic variable that is determined after receiving additional user data and advertising network data associated with the digital advertisement. The mean value 522 and standard deviations 524a, b may correspond to third metrics describing a third distribution of the non-deterministic variable. As additional data associated with the digital advertisement is acquired, the size of the standard deviation of the distribution of the non-deterministic variable decreases. For example, the size of standard deviation 524a is less than the size of standard deviation 514a.

After generating the mean value 522 and standard deviations 524a, b, in embodiments, the updated bid value at FIG. 5B may be subsequently updated to bid value 526a that is one standard deviation (e.g., standard deviation 524a) greater than the mean value 522. In other embodiments, the updated bid value bid value at FIG. 5B may be subsequently updated to bid value 526b that is two standard deviations (e.g., standard deviation 524a and standard deviation 524b) greater than mean value 522.

FIG. 5D is an illustration 530 of an example of updating a bid value based on fourth metrics describing a fourth distribution of a non-deterministic variable in accordance with embodiments of the disclosure. As previously described, in some embodiments over time when sufficient data associated with the digital advertisement is acquired, the standard deviation of the distribution of the non-deterministic variable may become a negligible amount. Illustration 530 may correspond to a third iteration of updating a bid value for the digital advertisement. For example, illustration 530 may be representative of metrics generated for a distribution of a non-deterministic variable that is determined after receiving user data and advertising network data associated with the digital advertisement in addition to the data received at FIG. 5C. The mean value 532 may correspond to a fourth metric describing a fourth distribution of the non-deterministic variable. Because sufficient data associated with the digital advertisement has been acquired, the standard deviation of the distribution has reached a negligible value and, thus, is not shown in illustration 530. Accordingly, the bid value of FIG. 5C may be updated to bid value 536 that corresponds to the mean value 532 of the distribution of the non-deterministic variable.

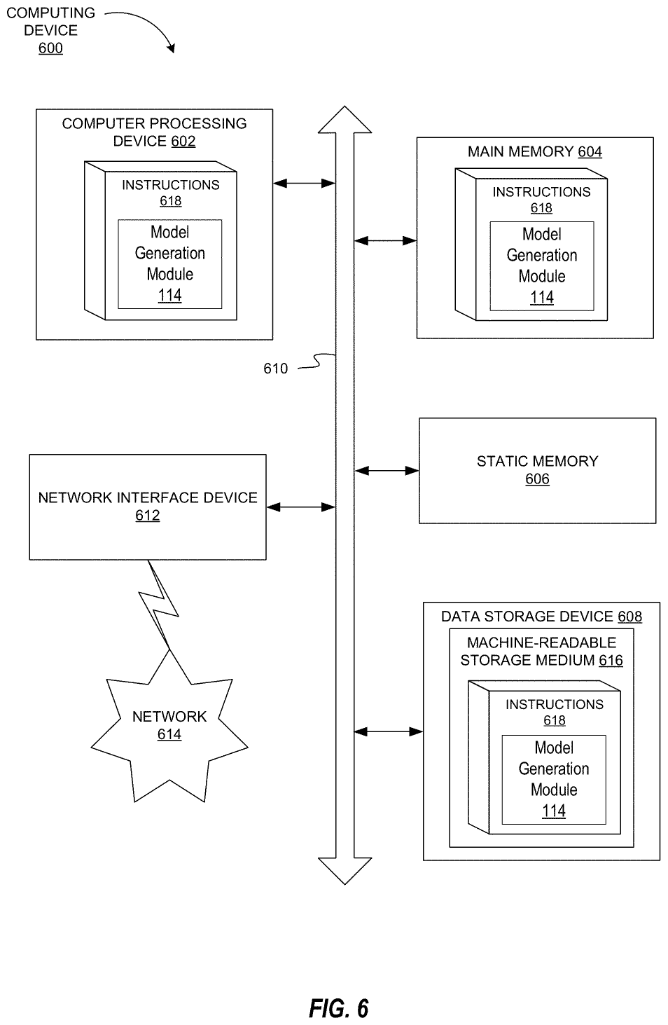

FIG. 6 is a block diagram of an example computing device 600 that may perform one or more of the operations described herein, in accordance with the present embodiments. The computing device 600 may be connected to other computing devices in a LAN, an intranet, an extranet, and/or the Internet. The computing device 600 may operate in the capacity of a server machine in client-server network environment or in the capacity of a client in a peer-to-peer network environment. The computing device 600 may be provided by a personal computer (PC), a set-top box (STB), a server, a network router, switch or bridge, or any machine capable of executing a set of instructions (sequential or otherwise) that specify actions to be taken by that machine. Further, while only a single computing device 600 is illustrated, the term “computing device” shall also be taken to include any collection of computing devices that individually or jointly execute a set (or multiple sets) of instructions to perform the methods discussed herein.

The example computing device 600 may include a computer processing device (e.g., a general purpose processor, ASIC, etc.) 602, a main memory 604, a static memory 606 (e.g., flash memory and a data storage device 608), which may communicate with each other via a bus 610. The computer processing device 602 may be provided by one or more general-purpose processing devices such as a microprocessor, central processing unit, or the like. In an illustrative example, computer processing device 602 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. The computer processing device 602 may also comprise one or more special-purpose processing devices such as an application specific integrated circuit (ASIC), a field programmable gate array (FPGA), a digital signal processor (DSP), network processor, or the like. The computer processing device 602 may be configured to execute the operations described herein, in accordance with one or more aspects of the present disclosure, for performing the operations and steps discussed herein.

The computing device 600 may further include a network interface device 612, which may communicate with a network 614. The data storage device 608 may include a machine-readable storage medium 616 on which may be stored one or more sets of instructions, e.g., instructions for carrying out the operations described herein, in accordance with one or more aspects of the present disclosure. Instructions 618 implementing a model generation module (e.g., model generation module 114 illustrated in FIG. 1) may also reside, completely or at least partially, within main memory 604 and/or within computer processing device 602 during execution thereof by the computing device 600, main memory 604 and computer processing device 602 also constituting computer-readable media. The instructions may further be transmitted or received over the network 614 via the network interface device 612.

While machine-readable storage medium 616 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer processing device, a computer, a system on a chip, or multiple ones, or combinations, of the foregoing. A computer processing device may include one or more processors which can include special purpose logic circuitry, e.g., an FPGA (field programmable gate array) or an ASIC (application-specific integrated circuit), a central processing unit (CPU), a multi-core processor, etc. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a smart phone, a mobile audio or media player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method, comprising:
generating data associated with one or more engagement events for a plurality of users;
aggregating the data associated with the one or more engagement events for the plurality of users; and
predicting, by a computer processing device, performance of one or more advertising campaigns based on the aggregated data.

2. The method of claim 1, wherein predicting the performance of the one or more advertising campaigns comprises using a statistical inference to calculate a probability of distribution for a valuation of the engagement event of the one or more advertising campaigns.

3. The method of claim 2, wherein the statistical inference comprises a Bayesian inference.

4. The method of claim 1, further comprising:
generating a model of a relationship between the one or more engagement events for the one or more advertising campaigns, wherein predicting the performance of the one or more advertising campaigns is based on the generated model.

5. The method of claim 1, further comprising:
generating a bid value for an advertisement in the one or more advertising campaigns based on the predicted performance.

6. The method of claim 5, further comprising:
receiving user data and advertising network data associated with the advertisement in the one or more advertising campaigns; and
updating the bid value for the advertisement based on the user data and the advertising network data.

7. The method of claim 1, wherein the one or more engagement events comprises at least one of a paid event or a valued event.

8. A system comprising:
a memory; and
a computer processing device, operatively coupled to the memory, to:
generate data associated with one or more engagement events for a plurality of users;
aggregate the data associated with the one or more engagement events for the plurality of users; and
predict performance of one or more advertising campaigns based on the aggregated data.

9. The system of claim 8, wherein to predict the performance of the one or more advertising campaigns, the computer processing device to use a statistical inference to calculate a probability of distribution for a valuation of the engagement event of the one or more advertising campaigns.

10. The system of claim 9, wherein the statistical inference comprises a Bayesian inference.

11. The system of claim 8, wherein the computer processing device is further to:
generate a model of a relationship between the one or more engagement events for the one or more advertising campaigns, wherein predicting the performance of the one or more advertising campaigns is based on the generated model.

12. The system of claim 8, wherein the computer processing device is further to:
generate a bid value for an advertisement in the one or more advertising campaigns based on the predicted performance.

13. The system of claim 12, wherein the computer processing device is further to:
receive user data and advertising network data associated with the advertisement in the one or more advertising campaigns; and
updating the bid value for the advertisement based on the user data and the advertising network data.

14. The system of claim 8, wherein the one or more engagement events comprises at least one of a paid event or a valued event.

15. A non-transitory computer readable storage medium storing instructions, which when executed, cause a computer processing device to:
generate data associated with one or more engagement events for a plurality of users;
aggregate the data associated with the one or more engagement events for the plurality of users; and
predict, by the computer processing device, performance of one or more advertising campaigns based on the aggregated data.

16. The non-transitory computer readable storage medium of claim 15, wherein to predict the performance of the one or more advertising campaigns, the computer processing device to use a statistical inference to calculate a probability of distribution for a valuation of the engagement event of the one or more advertising campaigns.

17. The non-transitory computer readable storage medium of claim 15, wherein the computer processing device is further to:
generate a model of a relationship between the one or more engagement events for the one or more advertising campaigns, wherein predicting the performance of the one or more advertising campaigns is based on the generated model.

18. The non-transitory computer readable storage medium of claim 15, wherein the computer processing device is further to:
generate a bid value for an advertisement in the one or more advertising campaigns based on the predicted performance.

19. The non-transitory computer readable storage medium of claim 18, wherein the computer processing device is further to:
receive user data and advertising network data associated with the advertisement in the one or more advertising campaigns; and
updating the bid value for the advertisement based on the user data and the advertising network data.

20. The non-transitory computer readable storage medium of claim 15, wherein the one or more engagement events comprises at least one of a paid event or a valued event.
